(19) United States
(12) Patent Application Publication
(10) Pub. No.: US 2008/0048887 A1
(43) Pub. Date: Feb. 28, 2008

(54) Vehicle occupant detection system

(75) Inventors: Hiroshi Aoki, Tokyo (JP); Masato Yokoo, Tokyo (JP); Yuu Hakomori, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/878,116

(22) Filed: Jul. 20, 2007

(30) Foreign Application Priority Data
Aug. 24, 2006 (JP) 2006-227846

(51) Int. Cl. G08G 1/017; H04N 9/68

(52) U.S. Cl. 340/937; 348/234; 348/E09.053

(57) ABSTRACT

A system is provided for detecting photographed images of a plurality of objects. In the object detection system, reflected lights reflected by a plurality of objects, i.e. an object A and an object B, are allowed to enter into a distance measuring imaging chip through an optical system, whereby produced images of the object A and the object B are entirely or partially superposed on each other on a predetermined imaging area of the distance measuring imaging chip. In addition, the object detection system is adapted to individually select between a state that only the object A is projected to the imaging area and a state that only the object B is projected to the imaging area by a shading filter.

### BACKGROUND

The disclosure is directed to the field of photographic imaging. Specifically, the present disclosure relates to a photographing system for obtaining photographs of a plurality of objects.

Features, aspects and advantages of the present disclosure will become apparent from the following description, appended claims, and the accompanying exemplary embodiments shown in the drawings, which are briefly described below.

Conventionally, there are known techniques for detecting an object occupying a vehicle seat by using a photographing unit such as a camera. For example, JP-A-2003-294855 discloses a configuration of an occupant detecting apparatus in which a single camera arranged in front of a vehicle occupant is used to detect the position of the vehicle occupant.

In such a case of using a camera to detect information about a vehicle occupant like the occupant detecting apparatus disclosed in the aforementioned JP-A-2003-294855, it is known that the vehicle occupant detection accuracy is deteriorated when the viewing angle of the camera is increased, for example, over 90° because the nearer the lens periphery, the smaller the light quantity for producing an image within the imaging area of an imaging chip through an optical lens and, in addition, the distortion of the produced image within the imaging area of the imaging chip is increased at the peripheral range as compared to the central range. Thus, for detecting both vehicle occupants on a driver seat and a front passenger seat at once, it is necessary to use an expensive lens which has more brightness and has reduced distortion aberration or to use a plurality of cameras, leading to increase in cost of the apparatus. In case of using a 3D camera to detect distance information of a vehicle occupant in order to obtain detailed information of the vehicle occupant such as position, posture, physique, and action, it is difficult to precisely detect desired information because deterioration of accuracy or variation of accuracy about detection of distance relative to the vehicle occupant may easily occur. Such problems occur not only in a camera installed in a vehicle for photographing a plurality of objects in a vehicle cabin but also in a camera for photographing a plurality of objects outside a vehicle and also in a camera for photographing a plurality of objects in a situation not related to the automobile. Therefore, in design of detection systems of this type, there is a demand for technology which is effective for precisely detecting desired information about a plurality of objects.

### SUMMARY

According to one embodiment, a photographing system for obtaining photographed images of a plurality of objects, includes a first light source for emitting irradiating light to a first object, a second light source for emitting irradiating light to a second object, a driving unit for driving the first light source and the second light source to switch between a first operating mode in which the light quantity of the first light source is larger than that of the second light source and a second operating mode in which the light quantity of the second light source is larger than that of the first light source, a photographing unit which has an optical system and an imaging chip to project images of the first object and the second object, entirely or partially superposed on each other, onto a predetermined imaging area of the imaging chip by allowing the reflected lights reflected at the first object and the second object to enter into the imaging chip through the optical system, a shading filter for blocking a part of incident lights entering into the imaging chip, and a control/calculation processor for outputting an image projected on the predetermined imaging area as image information, wherein when the driving unit is in the first operating mode, the shading filter blocks light of a quantity that is lower than that of the incident light which is emitted from the first light source and reflected at the first object to enter into the imaging chip and, based on the operation mode of the driving unit, the control/calculation processor outputs an image projected to the predetermined imaging area of the imaging chip as image information about the first object, and when the driving unit is in the second operating mode, the shading filter blocks light of a quantity that is lower than that of the incident light which is emitted from the second light source and reflected at the second object to enter into the imaging chip and, based on the operation mode of the driving unit, the control/calculation processor outputs an image projected to the predetermined imaging area of the imaging chip as image information of the second object.

According to another embodiment, a vehicle occupant detection system, including a photographing system and a detection processor for detecting information about the vehicle occupant such as physique, position, or posture of the vehicle occupant, based on the image information about either the first vehicle occupant or the second vehicle occupant outputted by the control/calculation processor of the photographing system.

According to yet another embodiment, an operation device controlling system includes a vehicle occupant detection system, an operation device which is operated based on the information about the vehicle occupant detected by the detection processor of the vehicle occupant detection system and an electronic control unit for controlling the actuation of the operation device.

A vehicle, comprising an engine system, a vehicle, including an engine system, an electrical system, an actuation control device for conducting the actuation control of the engine/running system and the electrical system and a vehicle occupant information detecting device for detecting information about a vehicle occupant on a vehicle seat such as physique, position, or posture of the vehicle occupant, wherein the vehicle occupant information detecting device comprises a vehicle occupant detection system.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is an illustration showing an object detection system for a vehicle according to one embodiment.

FIG. 2 is an illustration schematically showing a state of obtaining images by using the object detection system, according to one embodiment.

FIG. 3 is an illustration showing the state of an imaging area of a distance measuring imaging chip in a camera according to one embodiment.

FIG. 4 is an illustration showing the state of the imaging area of the distance measuring imaging chip in the camera, according to one embodiment.

FIG. 5 is a flow chart of an image information selecting control in the object detection system, according to one embodiment.

FIG. 6 is an illustration schematically showing an object detection system with an optical system, according to one embodiment.

### DETAILED DESCRIPTION

Embodiments of the present disclosure will be described below with reference to the accompanying drawings. It should be understood that the following description is intended to describe exemplary embodiments of the disclosure, and not to limit the disclosure.

For example, though the present disclosure is typically adapted to a photographing system in an automobile for obtaining photographed images of a plurality of objects on vehicle seats, the present disclosure can also be adapted to a photographing system for obtaining photographed images of a plurality of objects in a vehicle other than the automobile, such as an airplane, a boat, a train, and a bus, or in an area not related to a vehicle.

According to one embodiment, a photographing system for obtaining photographed images of a plurality of objects includes at least a first light source, a second light source, a driving unit, a photographing unit, a shading filter, and an image processor. The “object” here, used broadly, can include a vehicle occupant, an object placed on a vehicle seat, a child seat, and a junior seat and various objects in a situation not related to a vehicle.

The first light source is configured for emitting irradiating light to a first object and, on the other hand, the second light source is configured for emitting irradiating light to a second object which is different from the first object.

The driving unit is configured for driving the first light source and the second light source to switch between a first operating mode in which the light quantity of the first light source is larger than that of the second light source and a second operating mode in which the light quantity of the second light source is larger than that of the first light source. That is, the first operating mode or the second operating mode is exclusively and alternatively selected. Specific examples of the first operating mode are a state of actuating the respective light source to emit lights such that the quantity of irradiating light of the first light source is larger than the quantity of irradiating light of the second light source and a state of actuating the first light source to emit light and turning off the second light source not to emit light. On the other hand, specific examples of the second operating mode are a state of actuating the respective light source to emit lights such that the quantity of irradiating light of the second light source is larger than the quantity of irradiating light of the first light source and a state of actuating the second light source to emit light and turning off the first light source not to emit light.

The actuation timing of the driving unit in the first operating mode or the second operating mode and the switching timing for selecting one of the first operating mode or the second operating mode are controlled typically by a control unit mounted on the driving unit itself or a control processor provided separately from the driving unit.

The photographing unit has an optical system and an imaging chip to project images of the first object and the second object, entirely or partially superposed on each other, onto a predetermined imaging area of the imaging chip by allowing the reflected lights reflected at the respective objects, i.e. the first object and the second object, to enter into the imaging chip through the optical system. The optical system is configured for achieving optical function and is structured as an optical unit comprising a lens, a group of lenses, a prism, a mirror, or another optical element having a configuration capable of reflecting or deflecting light. The optical system is sometimes called an imaging system for contributing to image production. The “imaging chip” used here includes a 3D imaging chip (distance measuring imaging chip) for obtaining three-dimensional images and a 2D imaging chip for obtaining two-dimensional images.

A part of incident lights entering into the imaging chip is blocked by the shading filter. The image projected to the predetermined imaging area of the imaging chip is outputted as image information by the image processor. The image processor is configured for controlling the camera to obtain good quality images and controlling the image processing for processing photographed images to be used for analysis and a function of storing (recording) an operation control software, data for correction, buffer frame memory for preprocessing, defined data for recognition computing, and reference patterns.

According to one embodiment, when the driving unit is in the first operating mode, the shading filter blocks light of which quantity is lower than that of the incident light which is emitted from the first light source and reflected at the first object to enter into the imaging chip. That is, in case of the first operating mode in which the quantity of light of the first light source is larger than that of the second light source, lights, of which quantity is lower than that of the irradiating light from the first light source, such as ambient lights (natural light or sun light) and the irradiating light from the second light source are blocked by the shading filter and are thus prevented from entering into the imaging chip. Therefore, in the first operating mode, only the first object is projected to the predetermined imaging area of the imaging chip. Then, based on information that the driving unit is in the first operating mode, the image processor outputs an image projected to the predetermined imaging area of the imaging chip as image information about the first object. Therefore, in the first operating mode, information about the first object is obtained.

Alternatively, when the driving unit is in the second operating mode, the shading filter blocks light of which quantity is lower than that of the incident light which is emitted from the second light source and reflected at the second object to enter into the imaging chip. That is, in the case of the second operating mode in which the quantity of light of the second light source is larger than that of the first light source, lights, of which the quantity is lower than that of the irradiating light from the second light source, such as ambient lights (natural light or sun light) and the irradiating light from the first light source are blocked by the shading filter and are thus prevented from entering into the imaging chip. Therefore, in the second operating mode, only the second object is projected to the predetermined imaging area of the imaging chip. Then, based on information that the driving unit is in the second operating mode, the processor outputs an image projected to the predetermined imaging area of the imaging chip as image information of the second object.

According to one embodiment, the predetermined imaging area of the imaging chip of the photographing unit is used such that at least two focuses are formed on the common imaging area. In addition, the state that only the first object is projected to the imaging area and the state that only the second object is projected to the imaging area can be independently formed, whereby the common imaging area can be shared as the projecting areas of at least two objects. Therefore, this arrangement cures occurrence of decrease in brightness and distortion aberration at the periphery of the optical lens composing the optical system, thus allowing development of a miniaturized high-precision optical system. Therefore, the necessity for use of an expensive lens which has more brightness and has reduced distortion aberration or for use of a plurality of cameras can be avoided, thereby reducing the cost of the apparatus.

The system can be applied for obtaining photographed images of at least two objects. Further, the system can be applied to a case for obtaining photographed images of three or more objects, if necessary. For this arrangement, a photographing unit can be used which allows reflected lights reflected at a plurality of objects to enter into an imaging chip through an optical system such that images of the plurality of objects, entirely or partially superposed on each other, are projected to a predetermined area of the imaging chip.

According to another embodiment, the driving unit in the first operating mode actuates only the first light source to emit irradiating light and the driving unit in the second operating mode actuates only the second light source to emit irradiating light.

This arrangement of the photographing system allows such a control of turning on or turning off the respective light source, thereby simplifying the control as compared to the case that the respective light sources have a function of varying the light quantity.

According to another embodiment, the photographing system is structured as a vehicular photographing system to be installed in a vehicle. The vehicle can be various vehicles such as an automobile, an airplane, a boat, a train, a bus, and a truck.

The first light source emits irradiating light to a first vehicle occupant as the first object and the second light source emits irradiating light to a second vehicle occupant as the second object.

The photographing unit is adapted to project images of the first vehicle occupant and the second vehicle occupant, entirely or partially superposed on each other, onto the predetermined imaging area by allowing reflected lights reflected at the respective vehicle occupants, i.e. the first vehicle occupant and the second vehicle occupant, to enter into the imaging chip through the optical system.

According to one embodiment, when the driving unit is in the first operating mode, the shading filter blocks light of which quantity is lower than that of the incident light which is emitted from the first light source and reflected at the first vehicle occupant to enter into the imaging chip and, based on information that the driving unit is in the first operating mode, the processor outputs an image projected to the predetermined imaging area of the imaging chip as image information about the first vehicle occupant.

On the other hand, when the driving unit is in the second operating mode, the shading filter blocks light of which quantity is lower than that of the incident light which is emitted from the second light source and reflected at the second vehicle occupant to enter into the imaging chip and, based on information that the driving unit is in the second operating mode, the processor outputs an image projected to the predetermined imaging area of the imaging chip as image information of the second vehicle occupant.

The actuation timing of the light source in the first operating mode or the second operating mode is typically set to a timing when it is detected that an occupant gets in the vehicle, that is, specifically when it is detected that a seat belt buckle for the vehicle seat is latched or when it is detected by a weight sensor of a vehicle seat that an occupant sits in the vehicle seat. The switching timing for selecting one of the first operating mode and the second operating mode is suitably set based on a preset time schedule.

The arrangement of the photographing system reduces the occurrence of a decrease in brightness and distortion aberration at the periphery of the optical lens composing the optical system in the vehicle, thus allowing development of a miniaturized high-precision optical system. Therefore, this arrangement is effective for precisely detecting a plurality of vehicle occupants at once. Especially in case that the photographing unit is disposed in a limited space such as a vehicle, for example, it is difficult to precisely detect both vehicle occupants on a driver seat and a front passenger seat.

According to one embodiment, the vehicle occupant detection system comprises at least a detection processor in addition to the photographing system. The detection processor is configured for detecting information about the vehicle occupant such as physique, position, or posture of the vehicle occupant, based on the image information about either the first vehicle occupant or the second vehicle occupant outputted by the image processor of the photographing system. The information about the vehicle occupant detected by the detection processor is suitably used for control of an occupant restraining device, such as an airbag device, a seat belt device, and a warning device (for outputting display, sound and so on). According to the arrangement of the vehicle occupant detection system, information about the vehicle occupant can be precisely detected.

According to another embodiment, the operation device controlling system comprises at least: a vehicle occupant detection system, an operation device which is operated based on the information about the vehicle occupant detected by the detection processor of the vehicle occupant detection system; and a control device for controlling the actuation of the operation device. The operation device includes a warning apparatus for outputting warning signals, an apparatus for restraining an occupant by such as an airbag and a seat belt, and the like.

Therefore, according to the arrangement of the operation device controlling system, the actuation of the operation device is controlled in a suitable mode corresponding to the detection results of the information about the vehicle occupant by the vehicle occupant detection system. Accordingly, the fine control of the operation device is achieved.

According to yet another embodiment, a vehicle comprises at least an engine/running system; an electrical system; an actuation control device; and a vehicle occupant information detecting device. The engine/running system is a system involving an engine and a running mechanism of the vehicle. The electrical system is a system involving electrical parts used in the vehicle. The actuation control device is a device having a function of conducting the actuation control of the engine/running system and the electrical system. The vehicle occupant information detecting device is a device for detecting information about a vehicle occupant on a vehicle seat such as physique, position, or posture of the vehicle occupant. According to one embodiment, the vehicle occupant information detecting device comprises a vehicle occupant detection system.

According to this arrangement, there is provided a vehicle mounted with a vehicle occupant detection system capable of precisely detecting information about a vehicle occupant on a vehicle seat by a photographing unit.

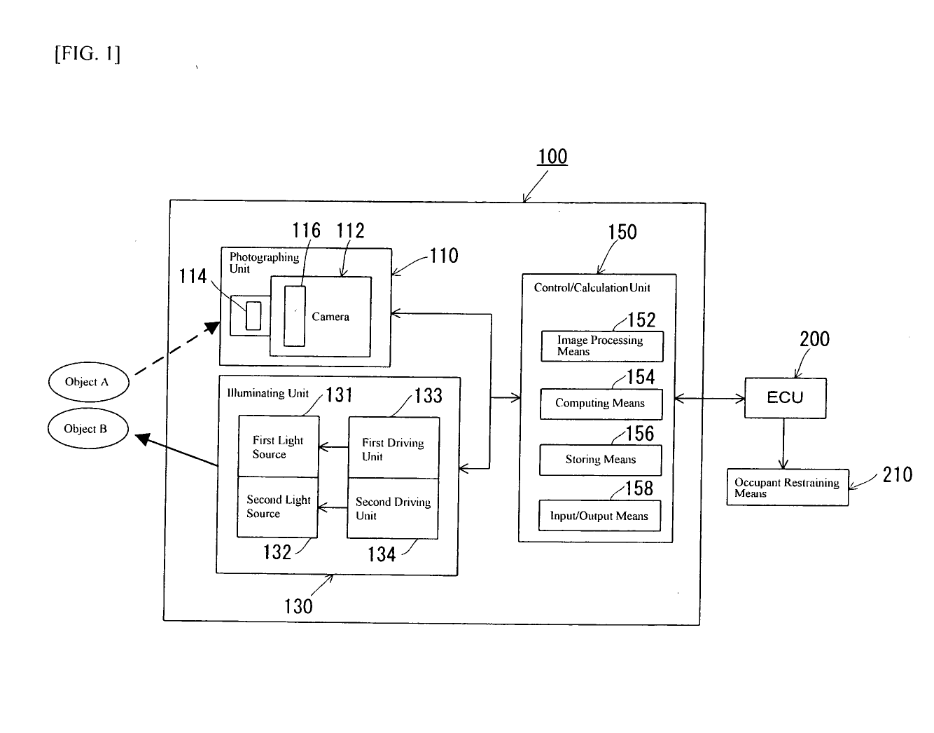

Hereinafter, description will be made in regard to an object detection system 100 as an embodiment of a “photographing system”, “vehicle occupant detection system”, or “vehicle occupant information detection device” with reference to FIG. 1 through FIG. 5.

The configuration of an object detection system 100, installed in a vehicle, is schematically shown in FIG. 1. The object detection system 100 is installed in the vehicle for detecting information about objects in a vehicle cabin such as vehicle occupants. As shown in FIG. 1, the object detection system 100 mainly comprises a photographing unit 110, an illuminating unit 130, and a control/calculation processor 150.

Further, the object detection system 100 cooperates together with an electronic control unit (ECU) 200 as an actuation control device for the vehicle and an occupant restraining device 210 to compose the occupant restraining apparatus for restraining a vehicle occupant in the event of a vehicle collision. The vehicle comprises, but not shown, an engine/running system involving an engine and a running mechanism of the vehicle, an electrical system involving electrical parts used in the vehicle, and an actuation control device (ECU 200) for conducting the actuation control of the engine/running system and the electrical system.

The photographing unit 110 of this embodiment comprises a camera 112 as the photographing device and a data transfer circuit (not shown). The camera 112 is a 3-D (three-dimensional) camera (sometimes called “monitor”) of a CCD (charge-coupled device) type in which light sensors are arranged into an array (lattice) arrangement. The camera 112 comprises an optical system 114 and a distance measuring imaging chip 116. The optical system 114 in this embodiment is configured for achieving optical function and is structured as an optical unit comprising a lens, a group of lenses, a prism, a mirror, or another optical element having a configuration capable of reflecting or deflecting light. The optical system 114 is sometimes called an imaging system for contributing to image production. The distance measuring imaging chip 116 is structured as a so-called “3D imaging chip” such as a CCD (charge-coupled device) chip for a 3D camera. Light incident on the distance measuring imaging chip 116 through the optical system 114 produces an image on a predetermined imaging area (“imaging area 116a” as will be described later) of the distance measuring imaging chip 116. The optical system 114 corresponds to the optical system and the distance measuring imaging chip 116 corresponds to the imaging chip.

By the camera 112 having the aforementioned structure, information about distance relative to an object A and an object B is measured a plurality of times to detect a three-dimensional surface profile which is used to identify the presence or absence, the size, the position, and the posture of each object. Also by the camera 112, information about light quantity or brightness of light incident on the distance measuring imaging chip 116 through the optical system 114 is detected. The principle of the camera 112 is a system in which distance from an object is measured by measuring the time required for light to return, i.e. the phase difference (time delay) between emitted light and reflected light returned from the object when the object is irradiated with modulated near-infrared light, that is, a so-called TOF (Time of flight) system. As the camera 112, a 3-D type monocular C-MOS camera or a 3-D type pantoscopic stereo camera may be employed.

The camera 112 of this embodiment is mounted, in a suitable embedding manner, to an area around an inner rearview mirror, an area around a side mirror, a central portion in the lateral direction of a dashboard, or the like of the automobile in such a manner as to face one or a plurality of vehicle seats. By using the camera 112, information about object(s) on one or more of the vehicle seats such as a driver seat, a front passenger seat, and a rear seat is measured periodically a plurality of times. Mounted on the object detection system 100 of this embodiment is a power source unit for supplying power from a vehicle battery to the camera 112, but not particularly illustrated. The camera 112 is set to start its photographing operation, for example, when the ignition key is turned ON or when a seat sensor (not shown) installed in the driver seat detects a vehicle occupant sitting in the driver seat.

According to one embodiment, the illuminating unit 130 comprises at least a first light source 131 and a second light source 132, a first driving unit 133 and a second driving unit 134. The first light source 131 is driven by the first driving unit 133 and the second light source 132 is driven by the second driving unit 134. The first light source 131 and the second light source 132 are adapted to irradiate the object(s) with modulated near-infrared light. The first driving unit 133 and the second driving unit 134 are structured as devices for driving the first light source 131 and the second light source 132 to act as mentioned above. Lights emitted from the first light source 131 and the second light source 132 and reflected by the object(s) are distributed to the camera 112. Particularly in this embodiment, the location and orientation of the first light source 131 and the second light source 132 are arranged such that the first light source 131 emits irradiating light to a vehicle occupant on the driver seat and the second light source 132 emits irradiating light to a vehicle occupant on the front passenger seat.

The first driving unit 133 and the second driving unit 134 are adapted to be controlled by the control/calculation processor 150 and drive the respective light sources based on control signal from the control/calculation processor 150. The first driving unit 133 and the second driving unit 134 may be separate driving units or a single driving unit. Alternatively, the first driving unit 133 and the second driving unit 134 may be provided with control functions themselves.

The control/calculation processor 150 of this embodiment further comprises at least an image processor 152, a computing processor (MPU) 154, a storage unit 156, an input/output unit 158, and peripheral devices (not shown). According to one embodiment, the control/calculation processor 150 can be implemented as a single processor. In the alternative, the control/calculation processor 150 comprises several sub processors for carrying out dedicated functions. The control/calculation processor 150 is configured for processing images projected to the predetermined imaging area of the distance measuring imaging chip 116 by the camera 112 to be outputted as image information and for deriving information about the object(s) on the driver seat and the front passenger seat based on the images.

The image processor 152 is configured for controlling the camera to obtain good quality images and for controlling the image processor for processing images taken by the camera 112 to be used for analysis. Specifically, as for the control of the camera, the adjustment of the frame rate, the shutter speed, and the sensitivity, and the accuracy correction are conducted to control the dynamic range, the brightness, and the white balance. As for the control of the image processing, the spin compensation for the image, the correction for distortion of the lens, the filtering operation, and the difference operation as image preprocessing operations are conducted and the configuration determination and the trucking as image recognition processing operations are conducted.

The computing processor 154 carries out a process of extracting information about the object based on the information from the image processor 152. Specifically, information about the presence, the size, the position, and the posture of the object are extracted (derived). When the object is a vehicle occupant, the presence of a vehicle occupant, the size (physique class) of the vehicle occupant, the positions of the occupant's head, shoulder, and upper body, and whether the occupant is out-of-position (OOP) are extracted (derived).

The storage unit 156 is configured for storing (recording) data for correction, buffer frame memory for preprocessing, defined data for recognition computing, reference patterns, and the computed results of the computing processor 154 a well as operation control software.

The input/output unit 158 inputs information about the vehicle, information about traffic conditions around the vehicle, information about the weather condition and about the time zone, and the like to the ECU 200 for conducting controls of the entire vehicle and outputs recognition results. Concerning the information about the vehicle, there are, for example, the state (open or closed) of a vehicle door, the wearing state of the seat belt, the operation of brakes, the vehicle speed, and the steering angle. In this embodiment, based on the information outputted from the input/output unit 158, the ECU 200 outputs actuation control signals to the occupant restraining device 210 as an actuation target. As the occupant restraining device 210, there is, for example, an apparatus for restraining an occupant by such as an airbag and a seat belt. The occupant restraining device 210 corresponds to the operation device. The ECU 200 is configured for controlling the actuation of the occupant restraining device 210. Therefore, the arrangement of the object detection system 100 plus the ECU 200 and the occupant restraining device 210 corresponds to the operation device control system. In addition to the occupant restraining device 210 as an embodiment of the operation device or instead of the occupant restraining device 210, the actuation of a warning device for outputting warning signals (display, sound and so on) may be controlled by the ECU 200.

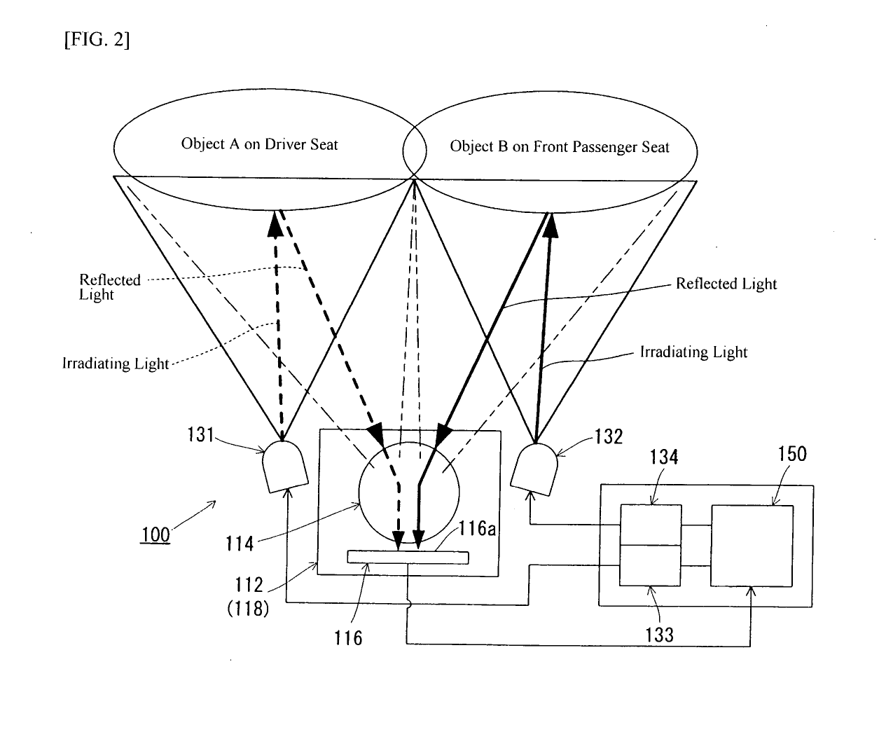

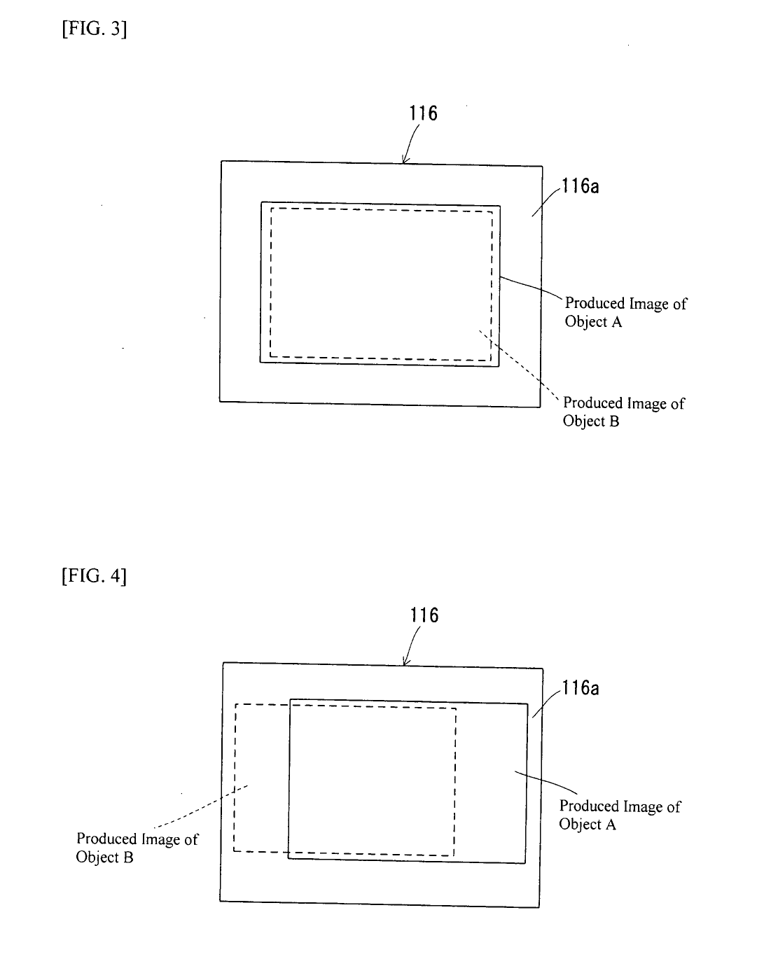

Hereinafter, the action of the object detection system 100 having the aforementioned structure will be specifically described with reference to FIG. 2 through FIG. 5. FIG. 2 schematically shows a state that photographed images are obtained by the object detection system 100 of this embodiment, and FIG. 3 and FIG. 4 show the state of the imaging area 116a of the distance measuring imaging chip 116 in the camera 112 of this embodiment.

As shown in FIG. 2, irradiating light from the first light source 131 and other ambient light (natural light or sunlight) are reflected by an object A on the driver seat and the reflected lights can enter into the distance measuring imaging chip 116 through the optical system 114. On the other hand, irradiating light from the second light source 132 and other ambient light (natural light or sunlight) are reflected by an object B on the front passenger seat and the reflected lights can enter into the distance measuring imaging chip 116 through the optical system 114. The object A used here includes a vehicle occupant and other objects occupying the driver seat. The object A corresponds to the “first object.” The object B used here includes a vehicle occupant and other objects occupying the front passenger seat. The object B corresponds to the “second object.”

According to one embodiment, lights reflected by the respective objects, i.e. the object A and the object B enter into the distance measuring imaging chip 116 through the optical system 114 and are introduced to the imaging area 116a (sometimes called “focal plane”) of the distance measuring imaging chip 116 where the lights are projected as images in which the object A and the object B are entirely or partially superposed on each other. That is, the camera 112 of this embodiment can photograph the object A and the object B such that they are superposed on the common imaging area of the distance measuring imaging chip 116, that is, the camera 112 is structured to have two focuses of the object A and the object B on the imaging area. The images of the object A and the object B at the imaging area 116a of the distance measuring imaging chip 116 may be substantially entirely superposed on each other as shown in FIG. 3 or partially superposed on each other as shown in FIG. 4. The imaging area 116a corresponds to the “predetermined imaging area.”

The camera of this embodiment is provided with a shading filter 118 for blocking a part of the incident lights. The shading filter 118 is a light blocking device which blocks (“shades” or “cuts”) lights in the state that the first and second light sources emit no light (sometimes referred to as “non-emitting state”), i.e. ambient light (natural light or sunlight) other than lights emitted from the light sources, to a level not to allow the distance measuring imaging chip 116 to detect such ambient light when the first light source 131 or the second light source 132 is in the light emitting state (sometimes referred to as “lighting state” or “irradiating state”).

By using the shading filter 118, when the first light source 131 is in the light emitting state and the second light source 132 is in the non-emitting state (corresponding to the “first operating condition”), two images of the object A and the object B which are produced by ambient light (natural light or sunlight) under normal circumstances are not detected by the distance measuring imaging chip 116 and only an image of the object A produced by irradiating light from the first light source 131 is detected by the distance measuring imaging chip 116 (hereinafter, referred to as “control mode A”). Similarly, when the second light source 132 is in the light emitting state and the first light source 131 is in the non-emitting state (corresponding to the “second operating condition”), two images of the object A and the object B which are produced by ambient light (natural light or sunlight) under normal circumstances are not detected by the distance measuring imaging chip 116 and only an image of the object B produced by irradiating light from the second light source 132 is detected by the distance measuring imaging chip 116 (hereinafter, referred to as “control mode B”).

In the case of photographing vehicle occupants by using a camera like the photographing unit 110, it is known that the detection accuracy is deteriorated because the brightness of the optical system is decreased as the viewing angle of the camera is increased, for example, over 90° and that a peripheral area of the lens is distorted as compared to a central area of the lens. Thus, for detecting both vehicle occupants on a driver seat and a front passenger seat at once, it is necessary to use an expensive lens which has more brightness and has reduced distortion aberration or to use a plurality of cameras, leading to increase in cost of the apparatus. In the case of using a 3D camera to detect distance information of a vehicle occupant in order to obtain detailed information of the vehicle occupant such as position, posture, physique, and action, it is difficult to precisely detect desired information because deterioration of accuracy or variation of accuracy about detection of distance relative to the vehicle occupant easily occur.

The photographing unit 110 of this embodiment is adapted to form two focuses of the object A and the object B on the common imaging area 116a of the distance measuring imaging chip 116 of the camera 112 and is adapted such that only information about the image of the object A is detected when the first light source 131 is in the light emitting state and only information about the image of the object B is detected when the second light source 132 is in the light emitting state. In this case, the focuses of the object A and the object B may be substantially entirely superposed on each other as shown in FIG. 3 or partially superposed on each other as shown in FIG. 4. This arrangement is configured to project images of the first object and the second object, entirely or partially superposed on each other, onto a predetermined imaging area of the imaging chip by allowing the reflected lights reflected by the respective objects, i.e. the first object and the second object, to enter into the imaging chip through the optical system and to project images of the first vehicle occupant and the second vehicle occupant, entirely or partially superposed on each other, onto the predetermined imaging area by allowing reflected lights reflected at the respective vehicle occupants, i.e. the first vehicle occupant and the second vehicle occupant, to enter into the imaging chip through the optical system.

According to the photographing unit 110 of this embodiment, two focuses of the object A and the object B can be formed on the imaging area 116a of the distance measuring imaging chip 116. In addition, the state that only the object A is projected to the imaging area 116a and the state that only the object B is projected to the imaging area 116a can be independently formed, whereby the common imaging area 116a can be shared as the projecting area for the object A and the projecting area for the object B. Therefore, this arrangement cures occurrence of decrease in brightness and distortion aberration at the periphery of the optical lens composing the optical system, thus allowing development of a miniaturized high-precision optical system. Therefore, the necessity for use of an expensive lens which has more brightness and has reduced distortion aberration or for use of a plurality of cameras can be avoided, thereby reducing the cost of the apparatus. In the case that the area of the imaging chip is divided into two areas to be used for the driver seat side and the front passenger seat side, an imaging chip having twice the number of pixels is required, leading to increase in cost. The photographing unit 110 of this embodiment can solve such problems and thus has a cost advantage.

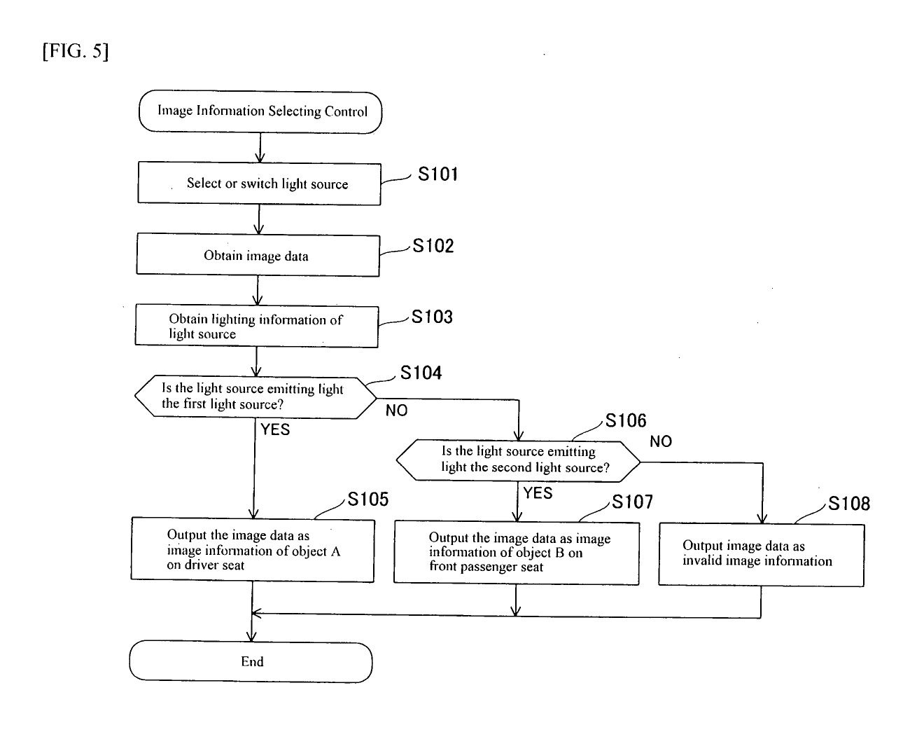

According to one embodiment, FIG. 5 is a flow chart of an “image information selecting control” in the object detection system 100. At step S101 in FIG. 5, a light source is selected from the first light source 131 and the second light source 132 or switched between them. Specifically, based on the control signal from the control/calculation processor 150, the first driving unit 133 and the second driving unit 134 are controlled to exclusively and alternatively select the control mode from the control mode A in which the first light source 131 is set in the light emitting state and the second light source 132 is set in the non-emitting state and the control mode B in which the first light source 131 is set in the non-emitting state and the second light source 132 is set in the light emitting state. The actuation timing of the light source in the control mode A or the control mode B is typically set to a timing when it is detected that an occupant gets on the vehicle, that is, specifically when it is detected that a seat belt buckle for the vehicle seat is latched or when it is detected by a weight sensor of a vehicle seat that an occupant sits in the vehicle seat. The switching timing for selecting one of the control mode A and the control mode B is suitably set based on a preset time schedule.

In the control mode A, only the first light source 131 is set in the light emitting state so that only light emitted from the first light source 131 and reflected by the object A is allowed to enter into the distance measuring imaging chip 116 through the optical system 114 because of the shading function of the shading filter 118. Therefore, in the control mode A, only the object A is projected to the imaging area of the distance measuring imaging chip 116. On the other hand, in the control mode B, only the second light source 132 is set in the light emitting state so that only light emitted from the second light source 132 and reflected by the object B is allowed to enter into the distance measuring imaging chip 116 through the optical system 114 because of the shading function of the shading filter 118. Therefore, in the control mode B, only the object B is projected to the imaging area of the distance measuring imaging chip 116.

Then, at step S102 in FIG. 5, a process for obtaining image data is conducted. In the case that the control mode A is set at step S101, image data of the object A projected on the imaging area of the distance measuring imaging chip 116 is obtained. On the other hand, in the case that the control mode B is set at step S101, image data of the object B projected on the imaging area of the distance measuring imaging chip 116 is obtained. That is, when the object of which image data is expected to be obtained is the object A on the driver seat, the control mode A in which only the first light source 131 is in the light emitting state is set. When the object of which image data is expected to be obtained is the object B on the front passenger seat, the control mode B in which only the second light source 132 is in the light emitting state is set. The setting result is stored in the storage unit 156 of the control/calculation processor 150.

At step S103 in FIG. 5, a process for obtaining lighting information of the light source by reading out the information stored in the storage unit 156 of the control/calculation processor 150. Step S103 is followed by step S104 where it is determined whether or not the light source which emits light is the first light source 131. When it is determined that the light source emitting light is the first light source 131 (Yes in step S104), the procedure proceeds to step S105. When not, that is, it is determined that the light source emitting light is the second light source 132 (No in step S104), the procedure proceeds to step S106.

At step S105, it is determined that the image data obtained at step S102 is for the object A on the driver seat and the image data is outputted as image information of the object A. Then, the image information selecting control is terminated.

The arrangement at step S105 corresponds to when the driving unit is in the first operating mode, the shading filter blocks light of which quantity is lower than that of the incident light which is emitted from the first light source and reflected at the first object to enter into the imaging chip and, based on the operation mode of the driving unit, the processor outputs an image projected to the predetermined imaging area of the imaging chip as image information about the first object and when the driving unit in the first operating mode, the shading filter blocks light of which quantity is lower than that of the incident light which is emitted from the first light source and reflected at the first vehicle occupant to enter into the imaging chip and, based on the operation mode of the driving unit, the processor outputs an image projected to the predetermined imaging area of the imaging chip as image information about the first vehicle occupant.

At step S106, it is further determined whether or not the light source which emits light is the second light source 132. When it is determined that the light source emitting light is the second light source 132 (Yes in step S106), the procedure proceeds to step S107. When it is determined that the light source emitting light is neither the first light source 131 nor the second light source 132 (No in step S106), the procedure proceeds to step S 108 where it is determined that the image data is invalid and the image information selecting control is terminated. At step S107, it is determined that the image data obtained at step S102 is for the object B on the front passenger seat and the image data is outputted as image information of the object B. Then, the image information selecting control is terminated.

The arrangement at step S107 corresponds to when the driving unit is in the second operating mode, the shading filter blocks light of which quantity is lower than that of the incident light which is emitted from the second light source and reflected at the second object to enter into the imaging chip and, based on the operation mode of the driving unit, the processor outputs an image projected to the predetermined imaging area of the imaging chip as image information of the second object and when the driving unit is in the second operating mode, the shading filter blocks light of which quantity is lower than that of the incident light which is emitted from the second light source and reflected at the second vehicle occupant to enter into the imaging chip and, based on the operation mode of the driving unit, the processor outputs an image projected to the predetermined imaging area of the imaging chip as image information of the second vehicle occupant.

In this manner, the image information of the object A on the driver seat and the object B on the front passenger seat can be precisely detected by the respective steps in the aforementioned image information selecting control. In this case, the distance from the camera 112 to the object A or the object B is obtained by measuring the time required for light to return i.e. the phase difference (time delay) between emitted light from the first light source 131 or the second light source 132 and reflected light as light reflected by and returned from the object. This measurement is conducted a plurality of times for each object so as to detect a three-dimensional surface profile of the object, thereby outputting various information such as the presence or absence, the size, the position, and the posture of the object. Based on the various information about the object, the ECU 200 outputs an actuation control signal to the occupant restraining device 210 so as to restrain a vehicle occupant on the driver seat or the front passenger seat by a suitable arrangement. Accordingly, the fine control of the occupant restraining device 210 is achieved.

Further, according to this embodiment, there is provided a vehicle with an object detection system 100 capable of precisely detecting information about an object on a vehicle seat by using the photographing unit 110.

Though the aforementioned embodiment has been described with regard to a case using a 3D (three-dimensional) camera as the camera 112, the present embodiment allows the use of a 2D camera for obtaining two-dimensional images instead of the camera 112. For applying this case in FIG. 2, among the components in the object detection system 100, the distance measuring imagining chip 116 which is a 3D imaging chip is replaced with a 2D imaging chip and the respective modulation functions for modulating near-infrared light of the first light source 131 and the second light source 132, the first driving unit 133 and the second driving unit 134 are omitted. This arrangement also cures occurrence of decrease in brightness and distortion aberration at the periphery of the optical lens composing the optical system, thus allowing development of a miniaturized high-precision optical system. It should be noted that, by the arrangement of using the camera with the 2D imaging chip, information such as the presence or absence, the outline, and the contour is outputted as the information about the object.

The present disclosure is not limited to the aforementioned embodiments and various applications and modifications may be made. For example, the following respective embodiments based on the aforementioned embodiments may be carried out.

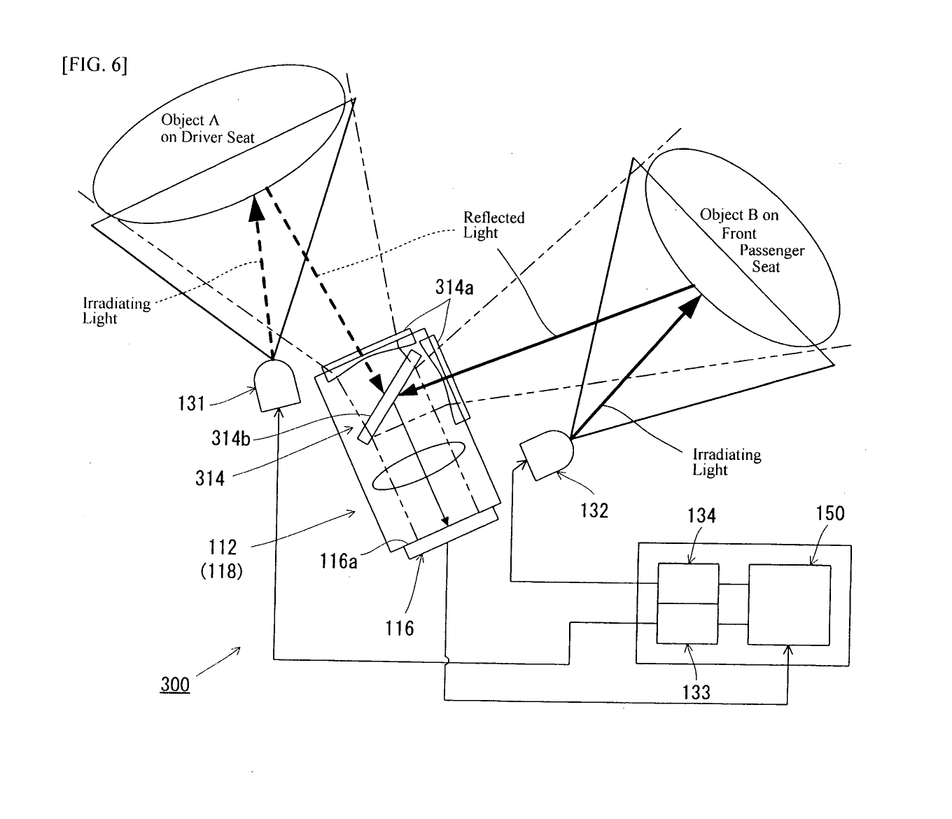

In the present disclosure, another arrangement different from the optical system 114 shown in FIG. 2 may be employed. FIG. 6 schematically shows an object detection system 300 with an optical system 314 according to another embodiment.

The object detection system 300 shown in FIG. 6 has the same structure as that of the aforementioned object detection system 100 except the optical system 314. The optical system comprises a half mirror 314b and plano-concave lenses 314a, 314a which are each disposed between the half mirror 314b and the object A on the driver seat or the object B on the front passenger seat and each have a concavity on the side facing the half mirror 314b. One plano-concave lens 314a is arranged to face the object A on the driver seat and the other plano-concave lens 314a is arranged to face the object B on the front passenger seat. The half mirror 314b is adapted to allow the reflected light from the object A on the driver seat to transmit to the distance measuring imaging chip 116 and to reflect the reflected light from the object B on the front passenger seat toward the distance measuring imaging chip 116. By using the optical system 314 having the aforementioned structure, a viewing field wider than that of the object detection system 100 is ensured. Thus, even when the driver seat or the front passenger seat is moved or the seat back is reclined, the object A and the object B are surely projected to the common imaging area 116a of the distance measuring imaging chip 116, thereby ensuring acquisition of desired information.

Though the aforementioned embodiments have been described with regard to a case for obtaining photographed images of two objects, i.e. the object A on the driver seat and the object B on the front passenger seat, the present disclosure can be applied to a case for obtaining photographed images of three or more objects, if necessary.

Though the aforementioned embodiments have been described with regard to a case that the second light source 132 is set in the non-emitting state in case of detecting information of image about the object A on the driver seat and the first light source 131 is set in the non-emitting state in case of detecting information of image about the object B on the front passenger seat, the present embodiment can employ a control method not setting the respective light sources in the non-emitting state. For example, for detecting image information about the object A on the driver seat, the second light source 132 is set to emit light weaker than that of the first light source 131. For detecting information of an image about the object B on the front passenger seat, the first light source 131 is set to emit light weaker than that of the second light source 132. Accordingly, such a control method can be employed.

In the present embodiment, the object to be detected through the camera 112 includes a vehicle occupant on a rear seat, an object placed on a vehicle seat, a child seat, and a junior seat, and a plurality of objects in a situation not related to a vehicle, as well as the vehicle occupant on the driver seat and the vehicle occupant on the front passenger seat. In this case, information about the object includes information about the presence, the size, the position, the distance, the posture, and the movement of the object, and the light quantity or brightness of incident light (distributed light) relative to the object.

Though the aforementioned embodiment has been described with regard to the arrangement of the object detection system to be installed in an automobile, the present embodiment can be adopted to object detection systems to be installed in various vehicles such as an automobile, an airplane, a boat, a train, a bus, and a truck, and object detection systems for detecting a plurality of objects inside or outside other than automobiles.

As described in the above, the disclosed system has several advantages. A photographing system obtaining photographed images of a plurality of objects employs a photographing unit allowing reflected lights reflected at respective objects such as a first object and a second object to enter into an imaging chip through a optical system such that images of the first object and the second object, entirely or partially superposed on each other, are projected to a predetermined area of the imaging chip and employs an arrangement of independently forming a state that only the first object is projected to the imaging area and a state that only the second object is projected to the imaging area through a shading filter, thereby precisely detecting photographed images of a plurality of objects.

The priority application, Japanese Patent Application No. 2006-227846, filed Aug. 24, 2006 including the specification, drawings, claims and abstract, is incorporated herein by reference in its entirety.

The foregoing description of a preferred embodiment has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A photographing system for obtaining photographed images of a plurality of objects, comprising:
a first light source for emitting irradiating light to a first object;
a second light source for emitting irradiating light to a second object;
a driving unit for driving the first light source and the second light source to switch between a first operating mode in which the light quantity of the first light source is larger than that of the second light source and a second operating mode in which the light quantity of the second light source is larger than that of the first light source;
a photographing unit which has an optical system and an imaging chip to project images of the first object and the second object, entirely or partially superposed on each other, onto a predetermined imaging area of the imaging chip by allowing the reflected lights reflected at the first object and the second object to enter into the imaging chip through the optical system;
a shading filter for blocking a part of incident lights entering into the imaging chip; and
a processor for outputting an image projected on the predetermined imaging area as image information, wherein
when the driving unit is in the first operating mode, the shading filter blocks light of a quantity that is lower than that of the incident light which is emitted from the first light source and reflected at the first object to enter into the imaging chip and, based on the operation mode of the driving unit, the processor outputs an image projected to the predetermined imaging area of the imaging chip as image information about the first object, and
when the driving unit is in the second operating mode, the shading filter blocks light of a quantity that is lower than that of the incident light which is emitted from the second light source and reflected at the second object to enter into the imaging chip and, based on the operation mode of the driving unit, the processor outputs an image projected to the predetermined imaging area of the imaging chip as image information of the second object.

2. A photographing system as claimed in claim 1, wherein the driving unit in the first operating mode actuates only the first light source to emit irradiating light and the driving unit in the second operating mode actuates only the second light source to emit irradiating light.

3. A photographing system as claimed in claim 1, wherein
the photographing system is structured as a vehicular photographing system to be installed in a vehicle, wherein,
the first light source emits irradiating light to a first vehicle occupant as the first object and the second light source emits irradiating light to a second vehicle occupant, different from the first vehicle occupant, as the second object;
the photographing unit is adapted to project images of the first vehicle occupant and the second vehicle occupant, entirely or partially superposed on each other, onto the predetermined imaging area by allowing reflected lights reflected at the first vehicle occupant and the second vehicle occupant, to enter into the imaging chip through the optical system;
when the driving unit is in the first operating mode, the shading filter blocks light of which quantity is lower than that of the incident light which is emitted from the first light source and reflected at the first vehicle occupant to enter into the imaging chip and, based on the operation mode of the driving unit, the processor outputs an image projected to the predetermined imaging area of the imaging chip as image information about the first vehicle occupant, and
when the driving unit is in the second operating mode, the shading filter blocks light of which quantity is lower than that of the incident light which is emitted from the second light source and reflected at the second vehicle occupant to enter into the imaging chip and, based on the operation mode of the driving unit, the processor outputs an image projected to the predetermined imaging area of the imaging chip as image information of the second vehicle occupant.

4. A vehicle occupant detection system comprising:
a photographing system as claimed in claim 3, and
a detection processor for detecting information about the vehicle occupant such as physique, position, or posture of the vehicle occupant, based on the image information about either the first vehicle occupant or the second vehicle occupant outputted by the processor of the photographing system.

5. An operation device controlling system comprising:
a vehicle occupant detection system as claimed in claim 4;
an operation device which is operated based on the information about the vehicle occupant detected by the detection processor of the vehicle occupant detection system; and
a control device for controlling the actuation of the operation device.

6. A vehicle, comprising:
an engine system;
an electrical system;
an actuation control device for conducting the actuation control of the engine/running system and the electrical system; and
a vehicle occupant information detecting device for detecting information about a vehicle occupant on a vehicle seat such as physique, position, or posture of the vehicle occupant, wherein
the vehicle occupant information detecting device comprises a vehicle occupant detection system as claimed in claim 4.

7. A vehicle occupant detection system, comprising:
a photographing system, comprising:
a first light source for emitting irradiating light to a first object;
a second light source for emitting irradiating light to a second object which is different from the first object;
a driving unit for driving the first light source and the second light source to switch between a first operating mode in which the light quantity of the first light source is larger than that of the second light source and a second operating mode in which the light quantity of the second light source is larger than that of the first light source;
a photographing unit which has an optical system and an imaging chip to project images of the first object and the second object, entirely or partially superposed on each other, onto a predetermined imaging area of the imaging chip by allowing the reflected lights reflected at the first object and the second object to enter into the imaging chip through the optical system;
a shading filter for blocking a part of incident lights entering into the imaging chip; and
a control/calculation processor for outputting an image projected on the predetermined imaging area as image information, wherein
when the driving unit is in the first operating mode, the shading filter blocks light of a quantity that is lower than that of the incident light which is emitted from the first light source and reflected at the first object to enter into the imaging chip and, based on the operation mode of the driving unit, the control/calculation processor outputs an image projected to the predetermined imaging area of the imaging chip as image information about the first object, and
when the driving unit is in the second operating mode, the shading filter blocks light of a quantity that is lower than that of the incident light which is emitted from the second light source and reflected at the second object to enter into the imaging chip and, based on the operation mode of the driving unit, the control/calculation processor outputs an image projected to the predetermined imaging area of the imaging chip as image information of the second object; and
a detection processor for detecting information about the vehicle occupant such as physique, position, or posture of the vehicle occupant, based on the image information about either the first vehicle occupant or the second vehicle occupant outputted by the control/calculation processor of the photographing system.

8. An operation device controlling system comprising:
a vehicle occupant detection system, comprising:
a photographing system, comprising:
a first light source for emitting irradiating light to a first object;
a second light source for emitting irradiating light to a second object which is different from the first object;
a driving unit for driving the first light source and the second light source to switch between a first operating mode in which the light quantity of the first light source is larger than that of the second light source and a second operating mode in which the light quantity of the second light source is larger than that of the first light source;
a photographing unit which has an optical system and an imaging chip to project images of the first object and the second object, entirely or partially superposed on each other, onto a predetermined imaging area of the imaging chip by allowing the reflected lights reflected at the first object and the second object to enter into the imaging chip through the optical system;
a shading filter for blocking a part of incident lights entering into the imaging chip; and
a control/calculation processor for outputting an image projected on the predetermined imaging area as image information, wherein
when the driving unit is in the first operating mode, the shading filter blocks light of a quantity that is lower than that of the incident light which is emitted from the first light source and reflected at the first object to enter into the imaging chip and, based on the operation mode of the driving unit, the control/calculation processor outputs an image projected to the predetermined imaging area of the imaging chip as image information about the first object, and
when the driving unit is in the second operating mode, the shading filter blocks light of a quantity that is lower than that of the incident light which is emitted from the second light source and reflected at the second object to enter into the imaging chip and, based on the operation mode of the driving unit, the control/calculation processor outputs an image projected to the predetermined imaging area of the imaging chip as image information of the second object; and
a detection processor for detecting information about the vehicle occupant such as physique, position, or posture of the vehicle occupant, based on the image information about either the first vehicle occupant or the second vehicle occupant outputted by the control/calculation processor of the photographing system; and
an operation device which is operated based on the information about the vehicle occupant detected by the detection processor of the vehicle occupant detection system; and
an electronic control unit for controlling the actuation of the operation device.

9. A vehicle, comprising:
an engine system;
an electrical system;
an actuation control device for conducting the actuation control of the engine/running system and the electrical system; and
a vehicle occupant information detecting device for detecting information about a vehicle occupant on a vehicle seat such as physique, position, or posture of the vehicle occupant, wherein
the vehicle occupant information detecting device comprises a vehicle occupant detection system, comprising:
a photographing system, comprising:
a first light source for emitting irradiating light to a first object;
a second light source for emitting irradiating light to a second object which is different from the first object;
a driving unit for driving the first light source and the second light source to switch between a first operating mode in which the light quantity of the first light source is larger than that of the second light source and a second operating mode in which the light quantity of the second light source is larger than that of the first light source;
a photographing unit which has an optical system and an imaging chip to project images of the first object and the second object, entirely or partially superposed on each other, onto a predetermined imaging area of the imaging chip by allowing the reflected lights reflected at the first object and the second object to enter into the imaging chip through the optical system;
a shading filter for blocking a part of incident lights entering into the imaging chip; and
a control/calculation processor for outputting an image projected on the predetermined imaging area as image information, wherein
when the driving unit is in the first operating mode, the shading filter blocks light of a quantity that is lower than that of the incident light which is emitted from the first light source and reflected at the first object to enter into the imaging chip and, based on the operation mode of the driving unit, the control/calculation processor outputs an image projected to the predetermined imaging area of the imaging chip as image information about the first object, and
when the driving unit is in the second operating mode, the shading filter blocks light of a quantity that is lower than that of the incident light which is emitted from the second light source and reflected at the second object to enter into the imaging chip and, based on the operation mode of the driving unit, the control/calculation processor outputs an image projected to the predetermined imaging area of the imaging chip as image information of the second object; and
a detection processor for detecting information about the vehicle occupant such as physique, position, or posture of the vehicle occupant, based on the image information about either the first vehicle occupant or the second vehicle occupant outputted by the control/calculation processor of the photographing system; and
an operation device which is operated based on the information about the vehicle occupant detected by the detection processor of the vehicle occupant detection system; and
an electronic control unit for controlling the actuation of the operation device.
